(19) United States
(12) Patent Application Publication
(10) Pub. No.: US 2013/0206450 A1
(43) Pub. Date: Aug. 15, 2013

(54) PLASTICIZER SYSTEM WITH IMPROVED ELECTRICAL PROPERTIES

(71) Applicants: Robert F. Eaton, Belle Mead, NJ (US); Abhijit Ghosh-Dastidar, East Brunswick, NJ (US); Jeffrey M. Cogen, Flemington, NJ (US); Bharat I. Chaudhary, Princeton, NJ (US); Caroline H. Laufer, Millington, NJ (US)

(72) Inventors: Robert F. Eaton, Belle Mead, NJ (US); Abhijit Ghosh-Dastidar, East Brunswick, NJ (US); Jeffrey M. Cogen, Flemington, NJ (US); Bharat I. Chaudhary, Princeton, NJ (US); Caroline H. Laufer, Millington, NJ (US)

(73) Assignee: Dow Global Technologies LLC, Midland, MI (US)

(21) Appl. No.: 13/878,858

(22) PCT Filed: Nov. 3, 2011
(86) PCT No.: PCT/US2011/059166

§ 371 Date: Apr. 11, 2013

Related U.S. Application Data
(60) Provisional application No. 61/410,657, filed on Nov. 5, 2010.

(51) Int. Cl. C08K 5/1515; H01B 3/30

(52) U.S. Cl. CPC C08K 5/1515; H01B 3/308
USPC 174/110 SR; 106/504; 524/114; 252/500

(57) ABSTRACT

The disclosure is directed to a plasticizer system with improved electrical properties. The plasticizer system includes (a) a primary plasticizer consisting of an epoxidized vegetable oil and (b) a secondary plasticizer consisting of an epoxidized fatty acid ester, where the primary plasticizer is present in an amount greater than 50% by weight of the total plasticizer system weight.

### BACKGROUND

Plasticizers such as di(2-ethylhexyl)phthalate (“DEHP”), di-isononyl phthalate (“DINP”), and other phthalate plasticizers have long been industry standard plasticizers used with polymers such as homo- and copolymers- of polyvinyl chloride (“PVC”), polyvinyl dichlorides (“PVDC”), vinyls, and similar polymers and resins to impart pliability and plasticity while retaining good tensile strength and resistance to cracking at low temperatures. For example, phthalate plasticizers have been used with rigid polymers such as PVC to create pliable materials used in such goods as intravenous (IV) bags and tubing, molded children's toys that require a soft or malleable feel, and various other applications where pliability or softness needs to be imparted to a polymer.

Phthalate plasticizers such as DEHP and DINP were once preferred plasticizers due to their ability to impart the physical characteristics noted above, and their permanence in the polymer over time, even when exposed to relatively high temperatures and humidity. However, public sentiment has prompted many manufacturers of consumer products to discontinue use of phthalates as a plasticizer due to concerns over potential adverse health effects. Thus, plasticizer compositions that reduce or eliminate phthalates, but perform similarly to DINP or other effective phthalate plasticizers, would be greatly appreciated in the art. Moreover, alternative non-phthalate plasticizers, which show an improved permanence in, and high compatibility with, a broad range of polymers would be greatly appreciated in the art.

Notable phthalate-free examples of plasticizers for use in PVC formulations include epoxidized soy oil. Unfortunately, epoxidized soy oil as sole PVC plasticizer is not able to meet the necessary balance of properties for many applications. Other epoxides have been identified as potential PVC plasticizers, including epoxies made from esters of fatty acids, the epoxy of 2-ethylhexanol, and epoxidized palm oil esters. Unfortunately, epoxides made from esters of fatty acids such as the epoxidized methyl ester of soy oil are too volatile to serve as useful plasticizers of PVC when used alone.

Recently, a replacement plasticizer system for phthalate-plasticized formulations was introduced that is compatible with other plasticizers, suitably nonvolatile, not petroleum-based, and capable of imparting thermal stability to formulations presently using phthalate plasticizers. It broadened the applications in which PVC, other halogenated polymers, acid-functionalized polymers, anhydride-functionalized polymers, and nitrile rubbers may be used. The plasticizer system provided an epoxidized fatty acid ester plasticizer as the primary plasticizer and a secondary plasticizer. The primary plasticizer represented at least 50% by weight of the total plasticizer system.

Suitable epoxidized fatty acid ester plasticizers include epoxidized biodiesel and epoxidized derivatives of fatty acid esters of biodiesel. As used therein, the term “biodiesel” meant mono-alkyl esters of long chain fatty acids derived from vegetable oils or animal fats.

Suitable secondary plasticizers include any plasticizer having a vapor pressure lower than that of the epoxidized fatty acid ester. Secondary plasticizers include epoxidized soy oil, epoxidized linseed oil, and epoxides of other vegetable oils as well as conventional plasticizers such as petroleum-based phthalates, chlorinated hydrocarbons, trimelitates, and phosphate-based plasticizers.

However, a need exists for a plasticizer system that has excellent electrical properties and low temperature properties. Excellent electrical properties of plasticizers are characterized as electrical resistivity above 1.0×10¹⁰ ohm-cm, and preferably above 1.1×10¹⁰ ohm-cm, measured according to ASTM D1169. Excellent low temperature properties of PVC compounds containing plasticizers include a low temperature brittleness performance as measured by ASTM D746 in degrees Celsius of less than 0 degrees Celsius, preferably less than −10 degrees Celsius.

### SUMMARY

The present disclosure is directed to plasticizers used in polymers to create desired physical characteristics, electrical properties, and low temperature performance in the resulting plasticizer-containing polymer compound. Desired physical properties include increasing flexibility, pliability, and plasticity. Desired electrical properties include having electrical resistivity above 5.1×10̂14 ohm-cm, measured according to D257. Desired low temperature performance includes having a low temperature brittleness as measured by ASTM D746 of below 0 degrees Celsius, preferably below −10 degrees Celsius.

In an embodiment, a plasticizer system is provided and includes (a) a primary plasticizer consisting of an epoxidized vegetable oil and (b) a secondary plasticizer consisting of an epoxidized fatty acid ester, where the epoxidized vegetable oil is greater than 50% by weight of the total plasticizer system weight.

Non-limiting examples of the epoxidized vegetable oil include epoxidized soy oil, epoxidized linseed oil, epoxidized palm oil, and combinations thereof.

In another embodiment, a plasticizer/polymer composition is provided and includes (a) a polymer selected from the group consisting of halogenated polymers, acid-functionalized polymers, anhydride-functionalized polymers, and nitrile rubbers and (b) a plasticizer system.

In another embodiment, an article of manufacture is provided and includes an electrical cable having an insulation layer made from or containing (a) a polymer selected from the group consisting of halogenated polymers, acid-functionalized polymers, anhydride-functionalized polymers, and nitrile rubbers and (b) a plasticizer system.

In another embodiment, a second article of manufacture is provided and includes coatings, adhesives, and castings made from or containing (a) a polymer selected from the group consisting of halogenated polymers, acid-functionalized polymers, anhydride-functionalized polymers, and nitrile rubbers and (b) a plasticizer system.

An advantage of the present disclosure is a plasticizer system.

An advantage of the present disclosure is an improved plasticizer system with improved electrical properties.

### BRIEF DESCRIPTION OF DRAWING

FIG. 1 shows the effect of the concentration of an epoxidized fatty acid methyl ester in an epoxidized soy oil on the volume resistivity.

FIG. 2 shows a predictive model for low temperature brittleness as a function of the concentration of an epoxidized fatty acid methyl ester and an epoxidized soy oil in a polyvinyl chloride polymer composition.

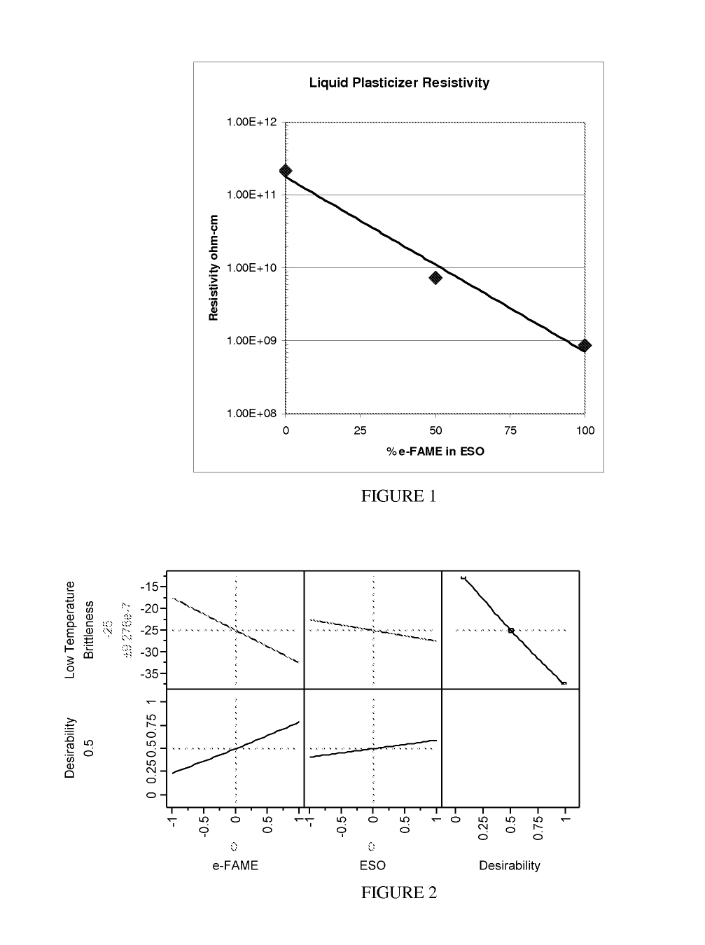

### DETAILED DESCRIPTION

The present disclosure is directed to a plasticizer system with improved electrical properties. The plasticizer system provided herein is suitable for use in electrical cables, coatings, adhesives, and castings in particular.

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent U.S. version is so incorporated by reference) especially with respect to the disclosure of synthetic techniques, product and processing designs, polymers, catalysts, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, flash point, viscosity, dielectric strength, percent weight, etc., is from 100 to 1,000, then the intent is that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, the amounts for components in the fluid and/or composition, additives, and various other components in the composition, and the various characteristics and properties by which these components are defined.

As used with respect to a chemical compound, unless specifically indicated otherwise, the singular includes all isomeric forms and vice versa (for example, “hexane”, includes all isomers of hexane individually or collectively). The terms “compound” and “complex” are used interchangeably to refer to organic-, inorganic- and organometal compounds.

The terms “comprising”, “including”, “having” and their derivatives are not intended to exclude the presence of any additional component, step or procedure, whether or not the same is specifically disclosed. In order to avoid any doubt, all compositions claimed through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

“Biodiesel” means herein mono-alkyl esters of long chain fatty acids derived from vegetable oils or animal fats. Preferably, the biodiesel is derived from vegetable oils.

“Polymer compound” means a formulated polymer composition.

“Blend,” “fluid blend” and like terms is a blend of two or more fluids, as well as blends of fluids with various additives. Such a blend may or may not be miscible. Such a blend may or may not be phase separated. Such a blend may or may not contain one or more domain configurations, as determined from light scattering, and any other method known in the art.

“Composition” and like terms is a mixture or blend of two or more components.

“Epoxidized vegetable oil,” as used herein, means vegetable oil wherein one or more of the double bonds have been epoxidized, i.e. vegetable oil comprising one or more epoxy groups on one or more fatty acid chains.

“Fatty acid ester,” as used herein, includes, as nonlimiting examples, methyl, ethyl, and 2-ethylhexyl esters of the fatty acids of soy bean oil.

“Volume Resistivity” is a resistance to leakage current through the body of an insulating material. The ratio of the potential gradient parallel to the current in a material to the current density. Under the International System of Units, volume resistivity is numerically equal to the direct-current resistance between opposite faces of a one-meter cube of the material (ohm-m). A lower volume resistivity indicates more conduction in insulation medium.

The present disclosure provides a plasticizer system. The plasticizer system includes (a) a primary plasticizer consisting of an epoxidized vegetable oil and (b) a secondary plasticizer consisting of an epoxidized fatty acid ester, where the primary plasticizer is present in an amount greater than 50% by weight of the total plasticizer system weight.

Nonlimiting examples of epoxidized vegetable oil include epoxidized soy oil, epoxidized linseed oil, epoxidized palm oil, and combinations thereof. Suitable examples of epoxidized soy oil include Plas-Check™ 775 from Ferro Corporation and Vikoflex™ 7170 from Arkema Inc.

Suitable epoxidized fatty acid ester plasticizers include epoxidized biodiesel and epoxidized derivatives of fatty acid esters of biodiesel.

Also, preferably, the epoxidized fatty acid ester is an epoxide of a fatty acid methyl ester. More generally, the epoxidized fatty acid ester can be any epoxidized fatty acid C₁-C₁₄ ester, including ethyl, propyl, butyl, and 2-ethylhexyl esters.

The epoxidized fatty acid ester can be prepared in a variety of conventional ways. For example, natural oils can be used as the starting material. In that instance, the natural oils can be saponified to the fatty acids and then esterified with alcohols. Next, the low molecular weight esters are epoxidized. The unsaturated ester can be epoxidized with a per-acid.

Alternatively, a glycidyl ester of the fatty acid can be prepared via epichlorohydrin or related chemicals. In yet another alternate, it is possible to transesterify the triglyceride with alcohols and then epoxidize the unsaturated fatty ester with a per-acid.

An example of preparing an epoxide of a fatty acid methyl ester begins with soy oil, wherein the soy oil is transesterified with methanol to make the methyl ester of the fatty acids in the oil. Glycerol is removed from the reaction products due to insolubility. A solution of per acetic acid in ethyl acetate is used to epoxidize the double bonds on the fatty acids. The per-acid is kept below 35% per acid and 35 degrees Celsius to prevent detonation. After completion, the ethyl acetate and product acetic acid are removed via vacuum stripping.

Preferably, the primary plasticizer will be present in an amount greater than 50% by weight of the total plasticizer system weight and in an amount less than about 85% by weight of the total plasticizer system weight.

Without being bound by any theory, it is believed that when the primary plasticizer is an epoxidized soy oil and the secondary plasticizer is an epoxidized fatty acid methyl ester, the epoxidized soy oil would preferably be present in an amount about 3 times greater than the epoxidized fatty acid methyl ester, thereby achieving a preferred improvement in low temperature brittleness as balanced against volume resistivity.

The present disclosure also provides a plasticizer/polymer composition. The plasticizer/polymer compositions includes (a) a primary plasticizer consisting of an epoxidized vegetable oil, (b) a secondary plasticizer consisting of an epoxidized fatty acid ester, and (c) a polymer selected from the group consisting of halogenated polymers, acid-functionalized polymers, anhydride-functionalized polymers, and nitrile rubbers, where the primary plasticizer is present in an amount greater than 50% by weight of the total plasticizer weight.

Preferably, the polymer is a halogenated polymer. More preferably, the halogenated polymer is a polyvinyl chloride (“PVC”) polymer selected from the group consisting of PVC homopolymers, PVC copolymers, polyvinyl dichlorides (“PVDC”), and polymers of vinylchloride with vinyl, acrylic and other co-monomers. Examples of other suitable halogenated polymers are chlorinated polyolefins and chlorinated rubbers.

Suitable acid-functionalized polymers include acrylic-acid functionalized polymers. Notably, the system is also useful with acrylic and other polymers that require plasticizers to reduce glass transitions or improve toughness.

The plasticizer/polymer composition may further comprise fillers, pigments, metal ion containing stabilizers, UV stabilizers, lubricants, metal soaps, oxides of stabilizers, additional plasticizers, and processing aids.

The present disclosure provides an article of manufacture. Suitable articles of manufacture include cables, coatings, adhesives, and castings. For example, when the article of manufacture is a cable, the cable may comprise one or more electrical conductors or a core of one or more electrical conductors wherein each conductor or core is surrounded by a layer made from or containing a plasticizer/polymer composition.

1. A plasticizer system composition comprising:
(a) a primary plasticizer consisting of an epoxidized vegetable oil and
(b) a secondary plasticizer consisting of an epoxidized fatty acid ester plasticizer, wherein the primary plasticizer is present in an amount greater than 50 percent by weight of the total plasticizer weight.

2. The plasticizer system composition of claim 1 wherein the secondary plasticizer is selected from the group consisting of epoxidized biodiesel and epoxidized derivatives of fatty acid esters of biodiesel.

3. The plasticizer system composition of claim 2 wherein the biodiesel is derived from a vegetable oil.

4. The plasticizer system of claim 2 wherein the epoxidized fatty acid ester is an epoxide of a fatty acid methyl ester.

5. The plasticizer system of claim 1 wherein the plasticizer system is phthalate free.

6. A plasticizer/polymer composition comprising:
a plasticizer system according to claim 1, and
(b) a polymer selected from the group consisting of halogenated polymers, acid-functionalized polymers, anhydride-functionalized polymers, and nitrile rubbers.

7. The plasticizer/polymer composition of claim 6 wherein the polymer is a polyvinyl chloride polymer (PVC) selected from the group consisting of PVC homopolymers, PVC copolymers, polyvinyl dichlorides (PVDC), and polymers of vinylchloride with vinyl, acrylic and other co-monomers.

8. An article of manufacture comprising the plasticizer/polymer composition according to claim 6.

9. An article of manufacture according to claim 8 wherein the article of manufacture is a cable comprising one or more electrical conductors or a core of one or more electrical conductors wherein each conductor or core is surrounded by a layer comprising the plasticizer/polymer composition.

10. An article of manufacture according to claim 8, wherein the article of manufacture is selected from the group consisting of a coating, an adhesive, and a casting.
